(19) United States
(12) Patent Application Publication
(10) Pub. No.: US 2025/0256253 A1
(43) Pub. Date: Aug. 14, 2025

(54) MODULAR UNIT FOR PREPARING FRICTION REDUCTION AGENT

(71) Applicant: ZL EOR CHEMICALS LTD., Vancouver (CA)

(72) Inventors: Ahmed ALJUBORI, Vancouver (CA); Fang Fang LIU, Vancouver (CA); Songyin LIU, Vancouver (CA)

(21) Appl. No.: 19/048,787

(22) Filed: Feb. 7, 2025

Related U.S. Application Data
(60) Provisional application No. 63/552,062, filed on Feb. 9, 2024.

(51) Int. Cl. B01F 35/21; B01F 23/50; B01F 31/00; B01F 35/22; B01F 35/30; B01F 35/71; B01F 101/00

(52) U.S. Cl. CPC B01F 35/21; B01F 23/551; B01F 31/57; B01F 35/2209; B01F 35/71805; B01F 2035/351; B01F 2101/2805

(57) ABSTRACT

As described herein, there is a polymer dispersion system comprising: (a) a first sub-system for transporting a fluid; (b) a modular unit for transporting dry materials; (c) a mixing device in fluid communication with the egress of the first sub-system and the egress of the modular unit; (d) a tank assembly comprising an ingress and an egress, the ingress of the tank assembly being in fluid communication with an egress of the mixing device; and (e) a transfer sub-system comprising an ingress that is coupled to the egress of the tank assembly. The modular unit may comprise a platform constructed of a frame and a first conveying unit. The platform comprises a conduit comprising a conduit inlet and a conduit outlet, a plurality of sealing mechanisms disposed around the platform inlet, and a vibrator. The first conveying unit in fluid communication with the conduit outlet.

### TECHNICAL FIELD

The present disclosure relates to a modular unit for preparing a friction reduction agent and for use in the oil and gas industry.

### BACKGROUND

Use of subterranean formation treatment fluids (e.g., polymer hydraulic fracturing fluids) is a common practice in a hydraulic fracturing operation in the oil and gas industry. Such fluids not only make it possible to reduce fracturing injection pressures, but also serve to reduce frictional forces in the injection pipes that may otherwise be present if other fracturing fluids or no fracturing fluids were used. Such reduction in frictional forces also increases the sand carrying capacity of the injected fluids in the frac process. The preparation of polymer hydraulic fracturing fluids, on demand and at the site of the hydraulic fracturing operation, is a continual point of interest for those who are active in the oil and gas industry.

The preparation of polymer hydraulic fracturing fluids can be done through apparatuses and systems commonly referring to as “polymer dissolution equipment”. Examples of such pieces of equipment have been previously discussed in the patent literature (see for example, international application number PCT/EP2009/063961, international application number PCT/FR2011/050262, and U.S. Pat. registration No. 9,067,182). Another example is the system described in PCT/CA2021/050281. PCT/CA2021/050281 discloses a polymer dispersion system (1000) comprising a water intake sub-system (1100), a dry materials intake sub-system (1200), a mixing sub-system (1300) for mixing water and dry material to form a mother solution, a plurality of pumps (1320, 1330) that are downstream of the eductor mixing sub-system (1300) for use in injecting mother solution towards further downstream hydraulic fracturing operations, and a programmable logic controller (1400) for controlling the various components of the polymer dispersion system (1000). For reference, a schematic of the polymer dispersion system disclosed in PCT/CA2021/050281 is included as FIG. 1 herein.

As described in PCT/CA2021/050281, a first conveying unit 1210 is used for conveying a dry material (e.g., dry polymer powder) from a dry material source (e.g., bulk containers “A”) to a containing unit 1220 within the dry materials intake sub-system 1200. Examples of conveying units include pneumatic conveying units and air blowing units (e.g., air slide conveyors). However, the connecting junctions between containers and conveying units in these existing systems often lack appropriate seals to limit or minimize the loss of dry material through such junction. The resulting “dust” created by such dry material that is not properly transferred from bulk container to conveying unit contaminates the work environment and presents a safety hazard for on-site personnel.

To address this issue, some operators have opted to use auger conveying units (as opposed to pneumatic or air blowing units). These auger units are often off-the-shelf products, with flexible auger units being preferred in the industry. However, these auger units are often large in size and require a certain distance and angle in order to operate properly. While motor and auger sizes may be increased, such increases also lead to increases in power consumption and a reduction in the flexibility and bend radius of the auger system. If the system dimensions or parameters lack the requisite distances or angles, the connection between the container and conveying unit is lost, resulting in a loss of dry material during the transfer process. Improperly sealed connection points and offloading of equipment may also lead to loss of dry material during the transfer process.

### SUMMARY

As described in a part of the present disclosure, there is a polymer dispersion system comprising: (a) a first sub-system for transporting a fluid; (b) a modular unit for transporting dry materials; (c) a mixing device in fluid communication with the egress of the first sub-system and the egress of the modular unit for preparing a friction reduction agent; (d) a tank assembly comprising an ingress and an egress, the ingress of the tank assembly being in fluid communication with an egress of the mixing device; and (e) a transfer sub-system comprising an ingress that is coupled to the egress of the tank assembly.

As described in another part of the present disclosure, the modular unit comprises a storage container, a platform, a first conveying unit, a collection chamber, and a second conveying unit. The configuration of such modular unit can limit or minimize the loss of dry material when transferring such dry material from a dry material storage container to conveying unit.

As described in yet another part of the present disclosure, the modular unit may comprise: (a) a platform constructed of a frame, the platform comprising: (i) a conduit comprising a conduit inlet and a conduit outlet; (ii) a plurality of sealing mechanisms disposed around the platform inlet; and (iii) a vibrator; and (b) a first conveying unit in fluid communication with the conduit outlet, wherein the modular unit is configured to be in communication with a programmable logic controller, the programmable logic controller for monitoring a seal between the conduit inlet and a container outlet of a container.

The plurality of sealing mechanisms may be disposed equidistant around the conduit and proximate to the conduit inlet. One or more of the plurality of sealing mechanisms may be spring loaded. One or more of the plurality of sealing mechanisms may comprise electric actuators for moving at least a part of the conduit from a first position to a second position. The conduit may be extendable and retractable. The conduit may be an expansion bellow.

The vibrator may be one of an air vibrator and an electric vibrator. The vibrator may be mounted onto the conduit. The vibrator may be mounted onto the frame of the platform. The first conveying unit may comprise an auger. The first conveying unit may comprise a first conveying unit outlet.

As described in yet another part of the present disclosure, there is a method for controlling a movement of a material through a modular unit. The method may comprise the steps of: (a) determining, by a programmable logic controller, if a connection between a conduit inlet of the modular unit and a container outlet of a container is sealed; (b) opening, by the programmable logic controller, a valve disposed in between the conduit inlet and the container outlet if the connection is determined to be sealed; and (c) inducing, by the vibrator, vibrations to one or more of the conduit and the frame of the platform. The method may further comprise the steps of: (d) delivering the material through the conduit outlet and to the first conveying unit; and (e) directing the material towards the first conveying unit outlet.

This summary does not necessarily describe the entire scope of all aspects of the disclosure. Other aspects, features and advantages will be apparent to those of ordinary skill in the art upon review of the following description of specific embodiments.

### BRIEF DESCRIPTION OF DRAWINGS

FIG. 1 is a schematic view of a prior art polymer dispersion system disclosed in PCT/CA2021/050281.

In the accompanying drawings following FIG. 1, which illustrate one or more embodiments;

FIG. 2 is a schematic side view of a polymer dispersion system comprising a modular unit for preparing a friction reduction agent; and

FIG. 3 is a perspective view of a platform forming a part of the polymer dispersion system depicted in FIG. 2.

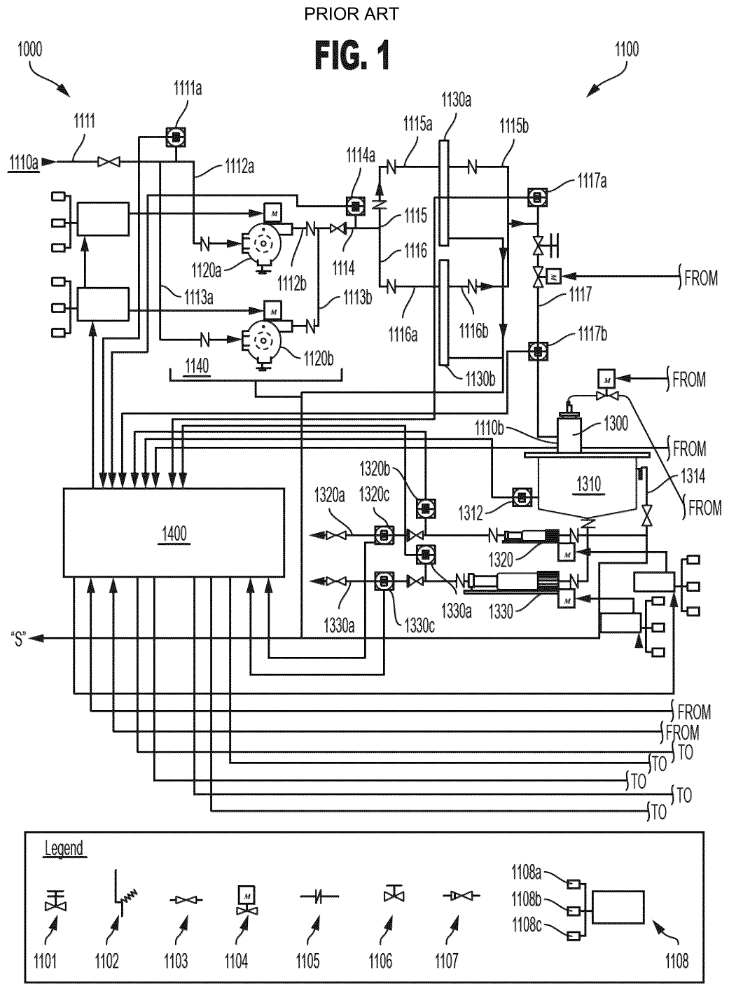

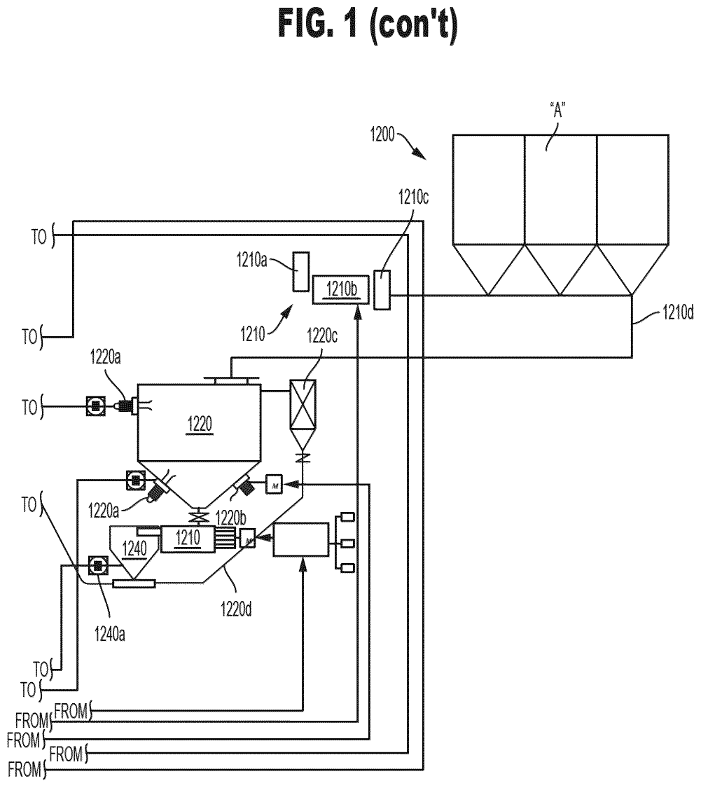

### DETAILED DESCRIPTION

Directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment. The use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one, for example, two or more, three or more, four or more, and the like.

As used herein, the term “about,” when used to describe a recited value, means within 5% of the recited value.

As used herein, the terms “comprising,” “having,” “including” and “containing,” and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method or use functions. The term “consisting of” when used herein in connection with a composition, use or method, excludes the presence of additional elements and/or method steps.

As used herein, the term “connected” may refer to any one of reversible coupling (e.g., nuts and bolts), irreversible coupling to (e.g., through welding), or two or more defined portions of an other integral object (e.g., the openings and extensions therefrom of an integral pipe elbow).

As used herein, the term “PLC” means programmable logic controller.

As used herein, the term “substantially” is intended to contemplate any and all variations or deviations of an art, process, value, machine, manufacture or composition of matter that are not of material effect.

Described in the present disclosure is a polymer dispersion system for preparing a polymer hydraulic fracturing fluid. The polymer dispersion system comprises: (a) a first sub-system for transporting a fluid; (b) a modular unit for preparing one or more friction reduction agents and for transporting dry materials; (c) a mixing device in fluid communication with the egress of the first sub-system and the egress of the modular unit for preparing a friction reduction agent; (d) a tank assembly comprising an ingress and an egress, the ingress of the tank assembly being in fluid communication with an egress of the mixing device; and (e) a transfer sub-system comprising an ingress that is coupled to the egress of the tank assembly.

The fluid can be any suitable fluid or combination of fluids known in the art, such as water. An example of the first sub-system is a sub-system that is designed to receive a liquid medium, such as a water intake sub-system that is designed to direct water towards the mixing device. The mixing device is used for mixing the fluid and the polymer in dry form together to form a polymer emulsion (also referred to as a “mother solution”). The tank assembly is for containing the formed polymer emulsion.

The polymer dispersion system may further comprise a transfer sub-system known in the art such as that described in PCT/CA2021/050281.

The polymer dispersion system may be portable and mobile, and may be brought onto the site of the hydraulic fracturing operation. The polymer dispersion system may be applicable to a single well operation or a zipper fracturing operation in the oil and gas industry. For larger operations like simultaneous fracturing operations, a plurality of polymer dispersion systems can be connected together to operate together.

### Polymer Dispersion System

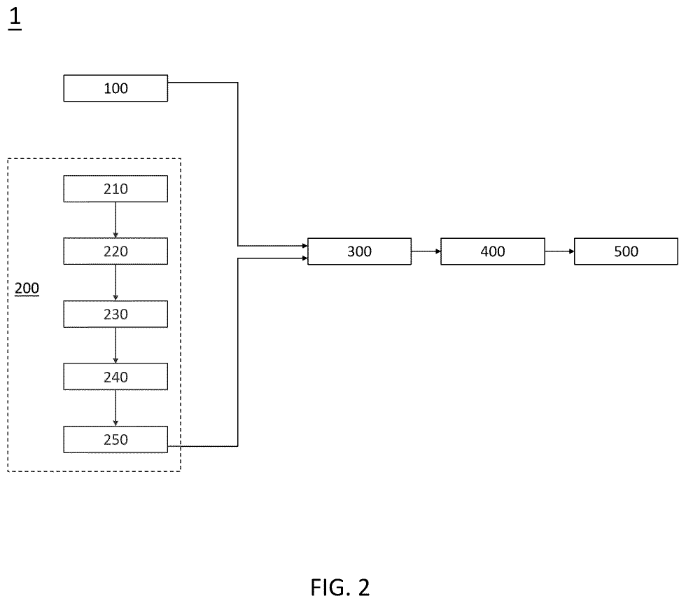

According to an embodiment of the polymer dispersion system, and referring to FIG. 2, there is a polymer dispersion system 1 comprising a water intake sub-system 100, a modular unit 200 for preparing one or more friction reduction agents, a mixing device 300, a tank assembly 400, and a transfer sub-system 500. System 1 further comprises a plurality of valves disposed at various suitable locations therein, the plurality of valves for regulating the flow of materials (e.g., water, polymer, polymer emulsion) through system 1. Examples of suitable valves include throttle valves, safety valves, ball valves, electric valve, disc valves, knife gate valves, shut-off valves, check valves, and any combination thereof.

A programmable logic controller (PLC, and not shown) is adapted to control various aspects and components of system 1 for ensuring operation of system 1. The PLC can be any PLC known in the art such as that disclosed in PCT/CA2021/050281 for example.

### Water Intake Sub-system

Referring to FIG. 2, there is a water intake sub-system 100 that forms a part of the polymer dispersion system 1. Water intake sub-system 100 may be similar in function to a water inlet circuit described in PCT/EP2009/063961 and PCT/CA2021/050281 for example. Water intake sub-system 100 can be one that is known in the prior art; for example, water intake sub-system 100 may be the one that is disclosed in PCT/CA2021/050281. Water intake sub-system 100 is connected with mixing device 300. Water intake sub-system 100 may be connected with mixing device 300 in a manner known in the prior art (e.g., PCT/CA2021/050281).

### Modular Unit

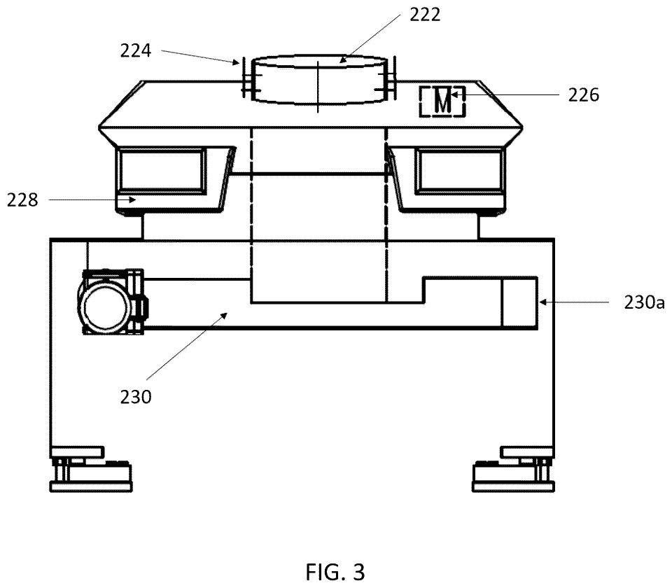

Referring to FIGS. 2 and 3, there is a modular unit 200 for preparing one or more reduction agents. Unit 200 comprises a storage container 210, a platform 220, a first conveying unit 230, a collection chamber 240, and a second conveying unit 250.

Storage container 210 is used for storing dry materials (e.g., dry polymer). As contemplated in this embodiment, storage container 210 is of a size and volume that can be transported on a bumper-pull trailer. Such efficiency in size and volume of storage container 210 also decreases the amount of energy required to operate the modular unit 200, compared to methods of operation prior art modular units for preparing a friction reduction agent. In other embodiments, the storage container can be of any suitable size and volume. Storage container 210 comprises an inlet (not numbered) for receiving dry material and an outlet 212 through which dry material is removed from storage container 210. Outlet 212 can be of any suitable shape. As contemplated in this embodiment, outlet 212 is circular in shape. In other embodiments, the outlet can be oval, triangular, rectangular, or any other suitable polygonal in shape. Storage container 210 can be made of any suitable material including, but not limited to, stainless steel and an inert plastic material.

Platform 220 comprises a conduit 222, a plurality of sealing mechanisms 224, and vibrator 226. The frame 228 of platform 220 can be constructed of a suitable sturdy material such as, but not limited to, carbon steel.

Conduit 222 comprises an inlet (unnumbered) for receiving dry material that passes through outlet 212 of storage container 210, and an outlet (unnumbered) opposite the inlet and through which dry material passes. As contemplated in this embodiment, conduit 222 is circular in shape and is also complementary to outlet 212 in one or more of size and shape. In other embodiments, the conduit of the platform can be of any suitable shape and size, provided that it is complementary to the shape and size of the outlet of the storage container. As contemplated in this embodiment, the body of conduit 222 comprises a portion that can be extended. A non-limiting example of such portion is an expansion bellow. Such expansion bellow can be manufactured of a suitable material such as, but not limited to, metal and rubber. In other embodiments, the conduit comprises two portions wherein one portion can be displaced relative to the other portion thereby extending the length of the body of the conduit. In other embodiments, the conduit does not comprise any extendable portion and the length of the body of the conduit remains fixed.

The plurality of sealing mechanisms 224 are for creating a seal between the inlet of the conduit 222 and outlet 212. Such seal is critical for limiting the loss of dry material while such material is delivered from storage container 210 to other parts of polymer dispersion system 1. A gasket or other suitable malleable seal (e.g., rubber seal) is disposed around the inlet of conduit 222 for filling in any spatial gaps that may exist between the inlet of the conduit 222 and outlet 212 when the two parts are coupled together. As contemplated in this embodiment, three or more sealing mechanisms 224 are disposed about equidistant apart around the sidewall of conduit 222. For example, modular unit 200 can have three sealing mechanisms 224 that are disposed equidistant apart around the sidewall of conduit 222. For example, modular unit 200 can have four sealing mechanisms 224 that are disposed equidistant apart around the sidewall of conduit 222. For example, modular unit 200 can have five sealing mechanisms 224 that are disposed equidistant apart around the sidewall of conduit 222. It has been found that an equidistant spatial arrangement provides a consistent seal between conduit 222 and outlet 212. In other embodiments, the plurality of sealing mechanisms 224 are not disposed equidistant apart around the circumference of conduit 222. As contemplated in this embodiment, the plurality of sealing mechanisms 224 are spring loaded and can further comprise electric actuators for moving inlet of conduit 222 towards outlet 212 to connect conduit 222 and outlet 212 together and to create the seal therebetween and for moving the inlet of conduit 222 away from outlet 212 to disconnect inlet 222 from outlet 212. The integrity of the seal between the inlet of conduit 222 and outlet 212 is monitored by a PLC such as, but not limited to, the one that is disclosed in PCT/CA2021050281. In other embodiments, other actuators such as, but not limited to, pneumatic actuators can be used.

Vibrator 226 is used for providing vibrations to conduit 222 for decreasing the likelihood of clogs in conduit 222 as dry material passes therethrough, thereby enabling dry material to flow through conduit 222. Vibrator 226 can be any suitable vibrator known in the art including, but not limited to, air vibrators and electric vibrators. As contemplated in this embodiment, vibrator 226 is powered by direct current. Vibrations from vibrator 226 are either directed to the frame of platform 228 (which are then indirectly transferred to conduit 222) or directed to conduit 222.

Outlet of conduit 222 is in communication with first conveying unit 230. First conveying unit 230 can be connected to conduit 222 by any suitable means known in the art. First conveying unit 230 can have an inlet (not shown) whose shape and size are complementary to the shape and size of outlet of conduit 222.

First conveying unit 230 is disposed below the outlet of conduit 222. As contemplated in this embodiment, first conveying unit 230 is an auger conveying unit. As contemplated in this embodiment, first conveying unit 230 is positioned horizontal or substantially horizontal to the ground. As contemplated in this embodiment, first conveying unit 230 is calibrated and rotates at a pre-determined speed that delivers a volume of dry material to collection chamber 240 at a pre-determined rate.

As contemplated in this embodiment, the outlet 230a of first conveying unit 230 (i.e., the end of first conveying unit 230 from which dry material is delivered into collection chamber 240) comprises a knife-gate valve. The PLC opens the knife-gate valve if the connection between outlet 212 and conduit 222 is deemed to be sealed by the PLC. Where the PLC does not deem the connection between outlet 212 and conduit 222 to be sealed, the valve remains closed thereby preventing dry material from passing through the outlet 230a of first conveying unit 230. In other embodiments, another suitable valve known in the art may be disposed at the outlet of the first conveying unit. In other embodiments, the PLC does not control the opening or closing of the valve disposed at the outlet of the first conveying unit. In other embodiments, the opening or closing of the valve disposed at the outlet of the first conveying unit is manually operated.

Referring to FIG. 2, it is contemplated in this embodiment that storage container 210, a platform 220, and a first conveying unit 230 are provided in duplicate (i.e., a first set of storage container 210, a platform 220, and a first conveying unit 230, and a second set of storage container 210, a platform 220, and a first conveying unit 230). Container 210 of each set is outfitted with one or more weight sensor (not shown). Each weight sensor is monitored by the PLC of polymer dispersion system 1. Only one set of container 210, a platform 220, and a first conveying unit 230 is in operation at any given time. When the weight of container 210 of the first set that is then in operation is below a threshold weight value, programmable logic controller: (a) will signal: (i) a valve in the first set (e.g. the valve disposed at the outlet 230a of first conveying unit 230 of the first set) to close; (ii) first conveying unit 230 to stop operation (e.g., if first conveying unit 230 is an auger, then the auger will stop rotating); or (iii) both (i) and (ii) above; and (b) concurrently signal or signal soon thereafter a valve in the second set (e.g. the valve disposed at the outlet of first conveying unit 230 of the second set) to open thereby permitting dry material from the second set to be directed towards collection chamber 240. The purpose of this duplication is to ensure that dry material is continually delivered into collection chamber 240 while one set of storage container 210, a platform 220, and a first conveying unit 230 is off-line or while one of the storage container 210 is replenished with dry material. In other embodiments, the polymer dispersion system comprises only one set of storage container 210, a platform 220, and a first conveying unit 230. In other embodiments, the polymer dispersion system comprises three or more sets of storage container 210, a platform 220, and a first conveying unit 230.

Collection chamber 240 is for receiving dry material from first conveying unit 230. Because dry material is delivered from first conveying unit 230 to collection chamber 240 at a pre-determined rate, the likelihood of clogs or loss of dry material is reduced. Collection chamber 240 is connected to second conveying unit 250. As contemplated in this embodiment, second conveying unit 250 is a vacuum hose that induces the dry material in collection chamber 240 to move within second conveying unit 250 by vacuum towards a mixing device 300 (e.g., eductor mixing device) of polymer dispersion system 1.

Mixing Device, Tank Assembly, and Transfer sub-system

Mixing device 300 is for mixing dry material and water together, and may be one that is known in the art such as, but not limited to, those disclosed in and PCT/CA2021/050281 for example.

Mixing device 300 has an egress that is in fluid communication with a tank assembly 400. The tank assembly 400 is used for containing a mother solution and may be one that is known in the art such as, but not limited to, those disclosed in and PCT/CA2021/050281 for example.

Tank assembly 400 is coupled to a transfer sub-system 500. Transfer sub-system 500 may be one that is known in the art such as, but not limited to, those disclosed in and PCT/CA2021/050281 for example.

### General

It is contemplated that any part of any aspect or embodiment discussed in this specification may be implemented or combined with any part of any other aspect or embodiment discussed in this specification. While particular embodiments have been described in the foregoing, it is to be understood that other embodiments are possible and are intended to be included herein. It will be clear to any person skilled in the art that modification of and adjustment to the foregoing embodiments, not shown, is possible.

Unless defined otherwise, all technical and scientific terms used herein have the same meaning as is commonly understood by one of ordinary skill in the art to which this invention belongs. In addition, any citation of references herein is not to be construed nor considered as an admission that such references are prior art to the present invention.

The scope of the claims should not be limited by the example embodiments set forth herein, but should be given the broadest interpretation consistent with the description as a whole.

What is claimed is:

1. A modular unit comprising:
(a) a platform constructed of a frame, the platform comprising: (i) a conduit comprising a conduit inlet and a conduit outlet; (ii) a plurality of sealing mechanisms disposed around the platform inlet; and (iii) a vibrator; and
(b) a first conveying unit in fluid communication with the conduit outlet;
wherein the modular unit is configured to be in communication with a programmable logic controller, the programmable logic controller for monitoring a seal between the conduit inlet and a container outlet of a container.

2. The modular unit as claimed in claim 1, wherein the plurality of sealing mechanisms are disposed equidistant around the conduit and proximate to the conduit inlet.

3. The modular unit as claimed in claim 2, wherein three to five sealing mechanisms are disposed around the conduit inlet.

4. The modular unit as claimed in claim 1, wherein one or more of the plurality of sealing mechanisms are spring loaded.

5. The modular unit as claimed in claim 1, wherein the conduit is extendable and retractable, and wherein one or more of the plurality of sealing mechanisms comprise electric actuators for moving at least a part of the conduit from a first position to a second position.

6. The modular unit as claimed in claim 5, wherein the conduit is an expansion bellow.

7. The modular unit as claimed in claim 1, further comprising a gasket disposed around the conduit inlet.

8. The modular unit as claimed in claim 1, where in the vibrator is one of an air vibrator and an electric vibrator.

9. The modular unit as claimed in claim 8, wherein the vibrator is mounted onto the conduit.

10. The modular unit as claimed in claim 8, wherein the vibrator is mounted onto the frame of the platform.

11. The modular unit as claimed in claim 1, where the first conveying unit comprises an auger.

12. The modular unit as claimed in claim 1, wherein the first conveying unit comprises a first conveying unit outlet.

13. A method for controlling a movement of a material through the modular unit as claimed in claim 1, the method comprising:
(a) determining, by the programmable logic controller, if a connection between the conduit inlet of the modular unit and the container outlet of the container is sealed;
(b) opening, by the programmable logic controller, a valve disposed in between the conduit inlet and the container outlet if the connection is determined to be sealed; and
(c) inducing, by the vibrator, vibrations to one or more of the conduit and the frame of the platform.

14. The method as claimed in claim 13, further comprising:
(d) delivering the material through the conduit outlet and to the first conveying unit; and
(e) directing the material towards the first conveying unit outlet.

15. The method as claimed in claim 14, wherein the material is directed towards the first conveying unit outlet at a pre-determined speed.

16. The method as claimed in claim 13, wherein the valve is a knife-gate valve.

17. A polymer dispersion system comprising: (a) a first sub-system for transporting a fluid; (b) a modular unit as claimed in claim 1; (c) a mixing device in fluid communication with an egress of the first sub-system and an egress of the modular unit; (d) a tank assembly comprising an ingress and an egress, the ingress of the tank assembly being in fluid communication with an egress of the mixing device; and (e) a transfer sub-system comprising an ingress that is coupled to the egress of the tank assembly.
